(19) United States
(12) Patent Application Publication
(10) Pub. No.: US 2016/0356605 A1
(43) Pub. Date: Dec. 8, 2016

(54) Active-Micro-Location-based Apparatus Method and services guide the user by light sign

(71) Applicants: Nissim Zur, Givataim (IL); Eliahu Arad, Tzofit (IL)

(72) Inventors: Nissim Zur, Givataim (IL); Eliahu Arad, Tzofit (IL)

(21) Appl. No.: 15/173,788

(22) Filed: Jun. 6, 2016

Related U.S. Application Data
(60) Provisional application No. 62/172,263, filed on Jun. 8, 2015.

(51) Int. Cl. G01C 21/20; H04W 4/18; H04W 4/00; H04W 4/02

(52) U.S. Cl. CPC G01C 21/206; H04W 4/025; H04W 4/18; H04W 4/008

(57) ABSTRACT

Novel Active-Micro-Location-based techniques that operate synergistically with existing Smart phone and Wi-Fi router to guide users with smart phone to a location. The Active-Micro-Location-based device has long range RF mesh connectivity. It has also a connection to several light signs (FIG. 2) and public screen (FIG. 3 38B) that visually guide the user toward the location of the product or service. The devices can mesh any location Id over all mesh network and a user with smart phone near one device can detect locations of products or services all over the mesh network. The user's smart phone has a unique color light sequence. The phone auto inquires the web data base for product with phone ID, a message is sent to all devices. From user location to the product's location to light the light boom with user unique color pattern. So user can navigate to unique location in multi stores areas.

### RELATED APPLICATIONS

This application claims priority from U.S. provisional patent Ser. No. 62/172,263 filing date Jun. 8, 2015 which is incorporated herein by reference.

### BACKGROUND

### Field of the Invention (Prior Art)

Field of the invention generally related to location-based services and, more specifically, to methods and systems of determining locations of Wi-Fi or Bluetooth Smart beacons devices, that RF transmitted ID to user, points smart phone to the iBeacons. The user uses phones apps with radar apps that show the distance to iBeacon. See Locator beacon and radar application for mobile device U.S. Pat. No. 8,878,671 B2

iBeacon is the trademark for an indoor positioning system that Apple Inc. calls “a new class of low-powered, low-cost transmitters that can notify nearby iOS 7 or 8 devices of their presence.” The technology enables a smart phone or other devices to perform actions when in close proximity to an iBeacon.

One application is to help smart phones determine their approximate location or context. With the help of an iBeacon, a smartphone's software can approximately find its relative location to an iBeacon in a store. iBeacon can help a phone show notifications of items nearby that are on sale, and it can enable payments at the point of sale (POS) where customers don't need to remove their wallets or cards to make payments. iBeacon technology works using the Bluetooth Low Energy (BLE) technology, also known as Bluetooth Smart.

iBeacon uses Bluetooth low energy transmit a universally unique identifier picked up by a compatible app or operating system. The identifier can then be looked up over the internet to determine the device's physical location or trigger an action on the device such as a check-in on social media or a push notification.

Various vendors have since made hardware iBeacons that come in a variety of form factors, including small coin cell devices.

How does it work?

The beacons themselves are small, cheap Bluetooth Smart transmitters. Apps installed on your Smart Phone listen out for the signal transmitted by these beacons and respond accordingly when the phone comes into range.

For example, if someone passes near a beacon in a shop, the retailer's app (assuming you have it installed) can display a special offer alert for you. On a visit to a museum, the museum's app would provide information about the closest display, using the distance from beacons placed near exhibits to work out the visitor's position. As such Beacons could be a much better option for in-door mapping—which GPS struggles with.

That should reduce the positing at least a bit. But there is certainly a risk of fatigue if you're being hassled all the way around the mall.

What “Problems” Exist in the Current iBeacon Technologies?

“problems” with Power consumption:

Since the iBeacons are powered by coin size batteries, They can't transmit to long range. Just up to 10-30 meters.

They can't be connected to mesh, since mesh consumes a lot of energy that will drain the battery

They can't connect to internet over Wi-Fi since Wi-Fi consumes 200 times more energy than coin cell battery is able to supply.

Since it transmits its beacon's ID all the time, the battery drains out very fast.

“Problems” with Prior Art as Located Place Using “Beacons”

The name iBeacon is used as “generic name” to all kind of Bluetooth Smart broadcast only profile beacons.
Since iBeacon intends to provide a Fix of product's location produces by RF UUID (ID) which is impossible to do by one beacon only. The phone can detect the distance to the iBeacon but not the direction to the product's location. Positioning systems typically work by having three or more reference points around the device being tracked. These positioning systems (triangulation) use the radio signals from these reference points in various ways to calculate the device's current location. Significant errors occur when there are an insufficient number of reference points or when the reference points lack balance or symmetry around the user. Arterial bias that emerges from the random model introduces many scenarios where the end user moves into physical areas in which there are only one iBeacon or other are not received or not in symmetrical way. This lack of symmetry in the distribution of reference points around the end user, causes the positioning algorithms (triangulation) to calculate the iBeacon device location with a great deal of error.
Since the broadcast is low, it gives low distance, thus it is impossible to detect the beacon ID outside the store arena's area. Thus it can't attract new shoppers to enter shops and has less attractively for the shop owners themselves.
When there are several iBeacons in near proximity, it is not possible to triangulation between several RF ID transmissions.
In big stores, with shelves and halls in between. iBeacon of one side of the shelves can transmit to the other of the shelves fence, and shopper will fool to look for the product in the wrong side of the fence hall.
IBeacon can't inform the shopper of its location by light beam since it has small coin battery and it is not a connected device to mains power. It has no way to detect the phone around it because it is a Bluetooth Smart broadcaster only device. Bluetooth Smart broadcaster is none smart phone connected profile.

“Problems” of RF Radiation Pollution.

iBeacon transmits by an RF beam its ID, all the time, An area with many iBeacons that produces RF radiation, are not healthy for humans, thus a shop with many iBeacons can't be treated as “green environment”.

### THE INVENTION SUMMARY

The invention provides an Active-Micro-Location-based devices, method of building Active-Micro-Location-based, and location beacon service using same.

Active-Micro-Location-based device has Wi-Fi, Bluetooth Smart and RF power amplifier for long range transmission. It is powered through USB from main's charger (220V/110V) or directly from mains (220V/110V).

Active-Micro-Location-based devices have USB port with pluggable USB female ports for light boom to direct the shopper to its location or direct him over halls to the location of the store and inside the store to the right shelves along the hall.

Active-Micro-Location-based smart phone apps will guide the user also with graphic signs and photos on the phone, and public screen of the real location.

The photos on phone's screen will be changed based on the user's location and proximity to Active-Micro-Location-based devices.

Active-Micro-Location-based device has ability to detect proximity to user's phone and to Active-Micro-Location-based smart phone apps, and activate external devices as light, door locker, elevate buttons etc.

Active-Micro-Location-based devices invention provides solution to the “problems” imposed by iBeacon technologies.

Solutions of the Power Consumption Problems:
Active-Micro-Location-based devices powered from the mains (220V/110V to low voltage as 5V), it does not need a coin battery. Therefore all the limitations from coin battery disappear.
With unlimited power source, Active-Micro-Location-based devices can transmit to long range.
Active-Micro-Location-based devices can be connected over Wi-Fi mesh, Bluetooth Smart mesh. Since high energy power mesh consumed is no problem with main power source. It can mesh all over the store and to bridge mall halls and all the way to all the other stores. The mesh can connect device to device over Wi-Fi to Wi-Fi, Wi-Fi Direct, or Wi-Fi to Bluetooth Smart. Or Wi-Fi to internet.
Active-Micro-Location-based devices connected to internet over Wi-Fi. High power consumption by Wi-Fi is not a problem, and it can be pulled from the internet, the light colored flashing logo pattern of the shopper to light its beam to direct the shopper.
Active-Micro-Location-based devices does not need to transmit its ID, since it detects the user's phone ID and gets the info from the internet. It can be RF Bluetooth Smart Observer profile only, Bluetooth Smart Observer profile do not RF transmit, it RF observes the presence of the user's smart phone Wi-Fi or Bluetooth Smart.

Solutions of the Active-Micro-Location-based devices.

Since Active-Micro-Location-based devices intend to provide a location of products been produces by detection the shopper's phone ID and then light the boom light flashing shopper unique color patterns. Every shopper can design unique color patterns. The shopper phone has unique ID, probably the phone's Wi-Fi or Bluetooth Smart MAC address.

When the shopper inquires about a product from the internet database, it sends the phone's ID too. This ID is sent also to the nearest Active-Micro-Location-based device.

The internet data base application will send the shopper unique color patterns, to be flashed on one of the booms of Active-Micro-Location-based devices near the shopper.

On mall's halls, the light booms will direct the shopper like-forward, left turn and right turn. Inside the shop as for the selected hall and pin-point the location.

Since the Active-Micro-Location-based device guides the shopper to a location by a light sign, it do not need to RF broadcast an ID. It can stay in an RF Observer mode. So no RF pollution is around.

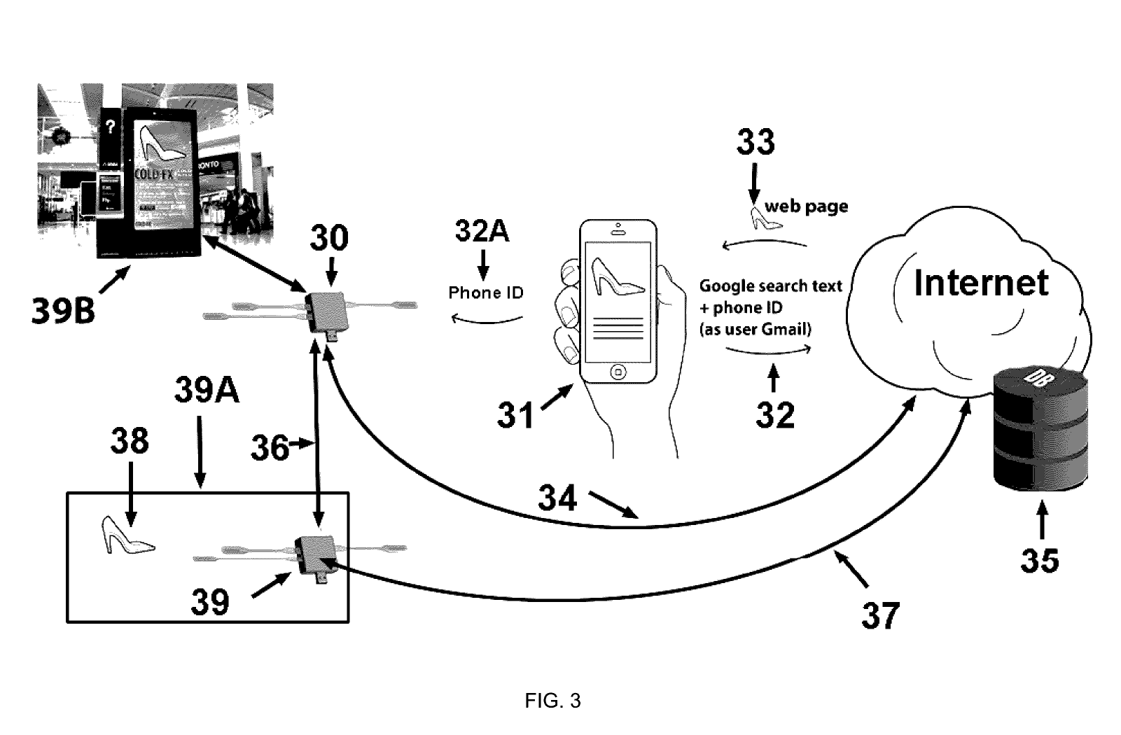

Since shoppers can search products using their phones, being near Active-Micro-Location-based devices is not needed. Any place within the mall is OK. Just need to be near some Active-Micro-Location-based devices anywhere. This can attract new shoppers to navigate easily, follow light signs or public screen (FIG. 3 image 39B Signage) to find and enter a shop. This is very attractive for shop owners since it increase shoppers to been exposed to their offers.

The guide light beam can be strips of RGB leds on the walls, ceiling, and floors, posts that show the user RGB logo and animate the direction he has to walk. It can guide in malls, hospitals or Airport terminals and any public places.

Every RGB led light strips can show several animated user's logos at the same time alone the line.

When there are several Active-Micro-Location-based devices in near proximity, it is possible to separate between them by looking and recognizing the light boom flashing for the shopper's color logo animated pattern, or name/ID of the shopper, on public screen.

In large shops, Active-Micro-Location-based devices of one side of the hall can transmit to the other hall's fence, but shoppers will follow the light boom and not enter the wrong hall.

Solutions of Active-Micro-Location-based Devices to “Problems” of RF Radiation Pollution.

The Active-Micro-Location-based devices do have 3 modes of operation, when all the 3 modes are uniquely designed to minimize RF radiation, in most case to zero.

Normal mode: listen Observer mode. Active-Micro-Location-based devices put its Wi-Fi part modem, on listen mode and Its Bluetooth Smart on Observer mode. In this mode there is zero RF radiation outside the Active-Micro-Location-based device. In this Observer mode, the Active-Micro-Location-based device, can detect nearby smart phone ID (as MAC address) without transmit any RF beam outside.

The Wi-Fi part, can listen to internet incoming information, after sending the phone ID.

Guide the use mode: When a shopper uses his smart phone to look for a product or service, in some area locations, its smart phone application sends a Wi-Fi with phone ID data to internet data base. The smart phone application sends the phone's ID over Bluetooth Smart as broadcaster profile data. The nearest Active-Micro-Location-based device, gets the Wi-Fi or Bluetooth Smart Phone ID data and forward it to internet data base, in a very short time, opens its Wi-Fi modem, less than a 0.2 msec. Then the shopper gets results from internet data base. Same internet data base gets the phone ID location from Active-Micro-Location-based devices near it. It gets the phone ID over shopper's phone internet searches and same for Active-Micro-Location-based device. This enables pin-point of the smart phone's location. So when a shopper asks to get navigation guidance to the location of a product or a service, the Active-Micro-Location-based device starts to light its attached public screen, boom or led strip light with shopper's logo animated color, when the shopper is near them, or on every hall junction.

User animated color is unique per shopper and build by the shopper or offered by the internet database service. It can animate background RGB colors with foreground animated RGB color and shapes.

The information on public screen can be any graphical and text that can help the shopper to navigate to location as seen on FIG. 3 image 39B.

The product can be show on public screen also without the shopper asked to be guides as hidden advertisement without user ID/logo/text.

Get distance mode: in some rare situations when shopper needs to get the distance from its phone to the nearest Active-Micro-Location-based device, the internet data base can continually transmits this information to the phone screen. Or sends a map with photos where the device is marked. The Active-Micro-Location-based device can receive the phone's ID RF power RSSI and report that to Internet data base.

Under another aspect of the invention is the ability of the internet database detects the shopper location, (in the shop near Active-Micro-Location-based devices to push store+product ID). This push information can also be used for instant payment system, as may need in cafe house.

Under another aspect of the invention, the shopper can stand in any location and scan a photo advertisement with QR code. Pulling the URL of the QR code, will start the sequence of “Guide the use mode” and all Active-Micro-Location-based devices with guiding the shopper to the designated location.

Under another aspect of the invention, the shopper can stand in any location and touch RFID device with his phone, as on product or service photo advertisement board. When the phone pulled the URL of RFID, it will start the sequence of “Guide the use mode” and all Active-Micro-Location-based devices will guide the shopper to the designated location.

Under another aspect of the invention, the shopper can stand in any location and his phone's microphone detects an ultra sound data comes from Active-Micro-Location-based devices or electronic advertisement device. The user smart phone will convert the ultra sound to data and pull the product's URL code. This will start the sequence of “Guide the use mode” and all Active-Micro-Location-based devices with guiding the shopper to the designated location.

Under another aspect of the invention, the shopper can stand in any location and his phone's camera detects a fast light intensity changes come from Active-Micro-Location-based devices or electronic advertisement device. The user's smart phone will convert the fast light intensity change to data and pull the product's URL code. This will start the sequence of “Guide the use mode” and all Active-Micro-Location-based devices with guiding the shopper to the designated location.

From the smallest storefront to the largest multi floors supermarkets.

Mobile is transforming the consumer experience.

Active-Micro-Location-based platform supports active micro location retail solutions.

It delivers user's smart phone context awareness and guides them.

It bridges the physical into the Digital.

The reverse beacon, active micro location retail solutions does not transmit any RF, as regular beacons.

It does not pollute the store with RF radiation. A full novel green environment solution.

It detects the user holding a smart phone without any apps on the user's phone. When a user Google for a product in a store and ask for walking guide.

A public light signs starts to glue and shows him the way when he is near a junction.

The light signs show the user a unique colored logo.

And since the Active-Micro-Location-based devices have mesh. All devices around the mall will show the direction when the user approaches.

Also public advertising on hall's public screens (FIG. 3 image 39B), can show relevant advertising video, just by sensing the nearby user's-phone.

The devices has an internal controlled light or ultra sound source that can transfer URL to user phone that stand in front of-it. For detailed information about the product. Connecting customers to stores and brands everything around them.

The Active-Micro-Location-based devices small size make it easy to put them anywhere. Active-Micro-Location-based empowers people by additional sense. The awareness digital sense. It's an entirely new way to deliver personalized services.

Active-Micro-Location-based with Google search profiles let you bring a personal touch to information and services.

So it can offer people the things they mostly like, at the location and moment they search.

And because it's based on context, the conversation always stays relevant even when people don't stay in one place.

Active-Micro-Location-base's all in one solution delivering more relevant information.

More rewarding experiences dome the power context awareness.

Shape the future of retailers beacon.

### DETAILED DESCRIPTION OF DRAWINGS

The principles and operation of a Active-Micro-Location-based device and mobile app according to the present invention may be better understood with reference to the drawings and the accompanying description but not limited to this exact shapes.

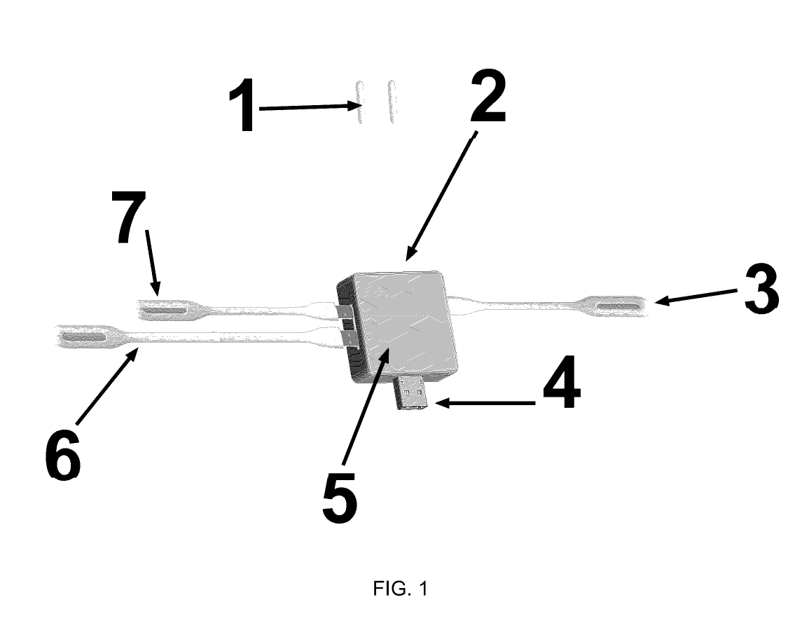

FIG. 1 depicts certain embodiments of the Active-Micro-Location-based devices
1. is a colored RGB strip light or strip of white led signal for the shopper.
2. Is second light arm locating that can flash in parallel for other shopper. Or forward a sign
3. Is light arm directed to turn right, more than one can be
4. Is USB power port to be plugged to wall charger or any power source. It can be plugged to USB power bank too or any power source connector.
5. The Active-Micro-Location-based device.
6. The light boom can be long or short with different shapes .it can be also full OLED public screen(signage).
7. Sample to short arm or signal other shopper. More than one cab be connected.

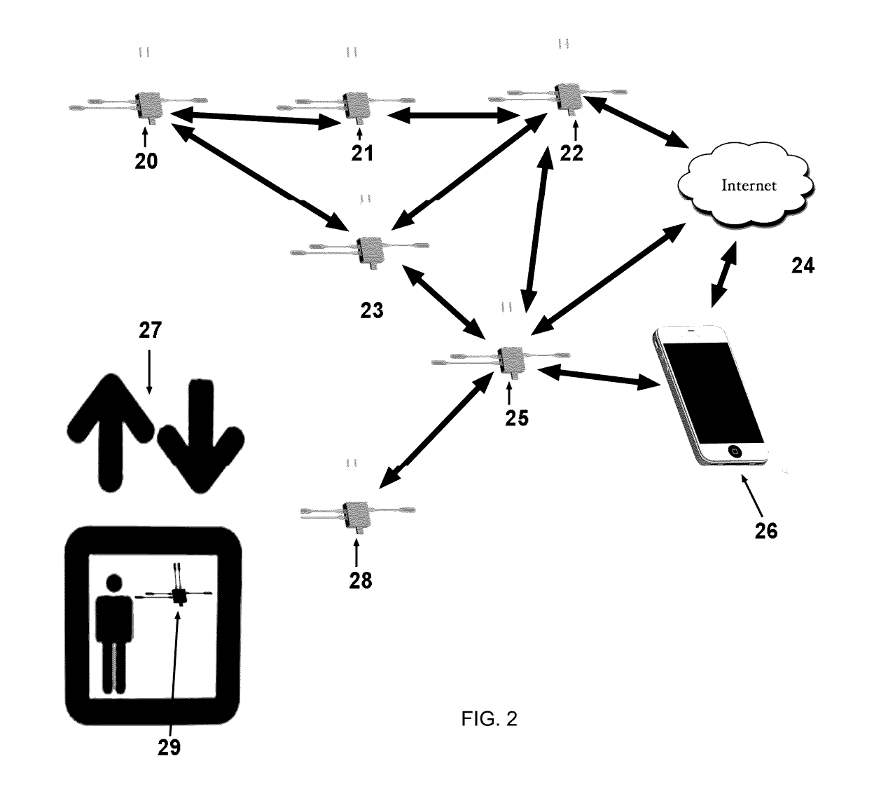

FIG. 2 depicts the Active-Micro-Location-based devices mesh network between themselves, the smart phone and the internet;

20,21,22,23,25,28,29 are samples Active-Micro-Location-based device units are mesh with other Active-Micro-Location-based devices units and link to internet 24 and to any smart phone 26 in its RF range. Unlimited Active-Micro-Location-based devices and phone can mesh.

The shopper's smart phone sends its RF ID (Wi-Fi or Bluetooth Smart Mac) to 25 and pull information from the internet 24.

The shopper's smart phone senses the 25 URL data over Ultra sound or Light intention changes and bridge the URL to internet 24.

The Active-Micro-Location-based device units guides the shopper by light boom with the shopper's unique animated logo, while he walks in halls. It can also guide him to be near an elevator by Active-Micro-Location-based device unit 28, and enter to elevator 27. In the elevator can be placed another Active-Micro-Location-based device unit 29 that can guide the shopper off the elevator on the right floor.

FIG. 3 depicts an example of Active-Micro-Location-based device unit scenario to illustrate the communication to pull products information and getting navigation to the location of product or service 39.

The shopper decides to search for a shoe in a mall. Launching the unique search apps, or web service as Google chrome, 31 and enter “female shoe”. The search apps, or just Google search knows the user's Google Gmail account, as unique for this phone service 31 and sends to internet data base 35 the phone ID, or user unique gmail account and the test search “female shoe” 32. This Phone ID is also broadcast 32A by phone apps to Active-Micro-Location-based device unit 30 over Bluetooth Smart or Wi-Fi.

Phone ID is the phone Wi-Fi MAC address or/and Bluetooth Smart MAC address.

The internet data base gets the phone location by message 34 send from Active-Micro-Location-based device unit 30. Now the Internet database pin-point the phone location (near known Active-Micro-Location-based 30).

The internet data base reply 33 to phone search apps 31 if there is an offer for “female shoe” in the near area, as in place 39A.

If the shopper reads all information about the “female shoe” and asked to be guided to area 39A, he clicks on the web page result or apps button, notifying the internet data base. The internet data base updates all Active-Micro-Location-based device units from phone location to area 39A with user's ID and user's animated color logo.

User animated color can be also a combination of text, image, name, video, sound on public screen too (public screen, as Signage, 39B) This invention did not limit the scope to only these public screen examples.

Active-Micro-Location-based devices that connected to public advisement monitors can show the info Relevant advisement with or without user's guide request.

The Active-Micro-Location-based device units 30 near range shopper, light one of its light booms with user animated logo, to direct him on his walking path. Every Active-Micro-Location-based device units on every junction will get the proximity to user's phone ID 32A and flash on one of its light boom the shopper animated logo. The animated colored light is active only on close proximity to the shopper phone, since the shopper apps sends a phone ID 32A. When the shopper walks away, the light closed. In this way every the lighted sign can support many walking shoppers to many locations. When the shopper approaches area 39A, Active-Micro-Location-based device unit 39 guides it to the shoe 38.

If there is no internet connection, a message can be broadcast all over by mesh link as 36. So all Active-micro-Location-based device units know the phone ID, the target area 39A, 39, and the phone animated logo.

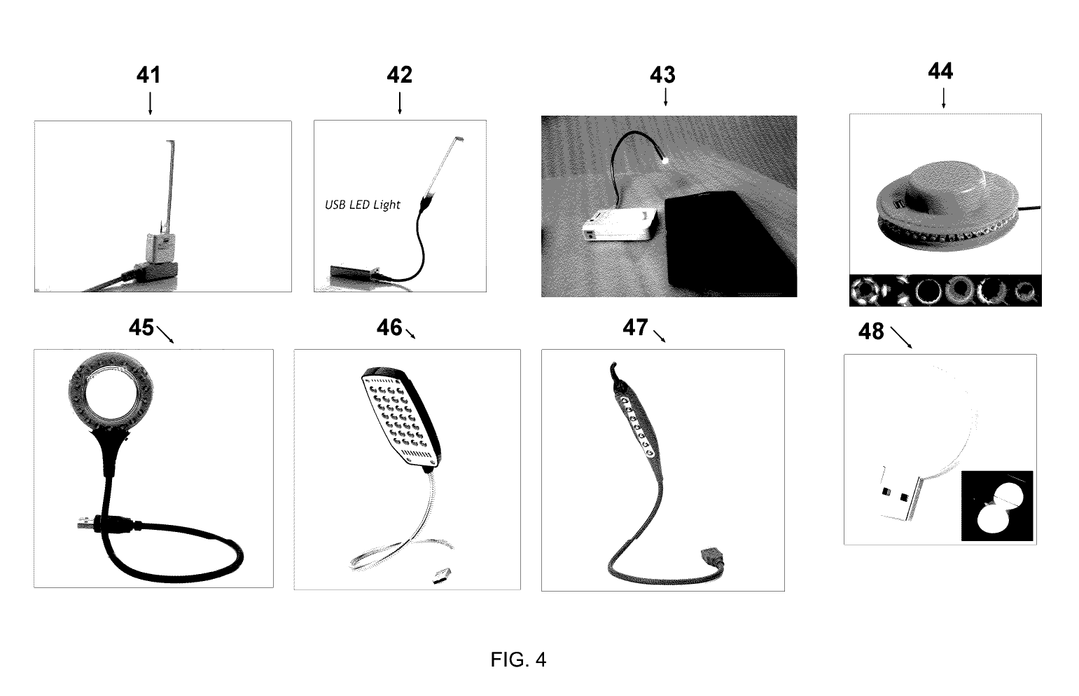

FIG. 4 depicts an example using different light boom to guide the shopper. This invention did not limit the scope to only these examples. Also a big public sign as LCD/OLED etc can be used by Active-Micro-Location-based device units to guide the shopper

Solid boom light 41 plugged to Active-Micro-Location-based device units devices power from 220V110V. Flexible boom light 42 plugged to Active-Micro-Location-based device, the flexible boom makes it easy for shops to hide the Active-Micro-Location-based device units body and show only the lighted boom.

Flexible boom light 43 plugs to Active-Micro-Location-based device, that has internal rechargeable battery as USB power bank. This covers area that has no connection to power from wall socket as 220V/110V.

A round light boom 44 plugged to Active-Micro-Location-based device units. For places needed a flat visual guidance as tables, walls etc.

A ring light flexible boom 45 plugged to Active-Micro-Location-based device units

An array of color RGB leds on flexible boom 46 plugged to Active-Micro-Location-based device units. This can animate a 2D shopper logo.

A device with shape of the product on flexible boom 47 plugged to Active-Micro-Location-based device units

A round, lamp shape 48 RGB leds on flexible boom 46 plugged to Active-Micro-Location-based device units

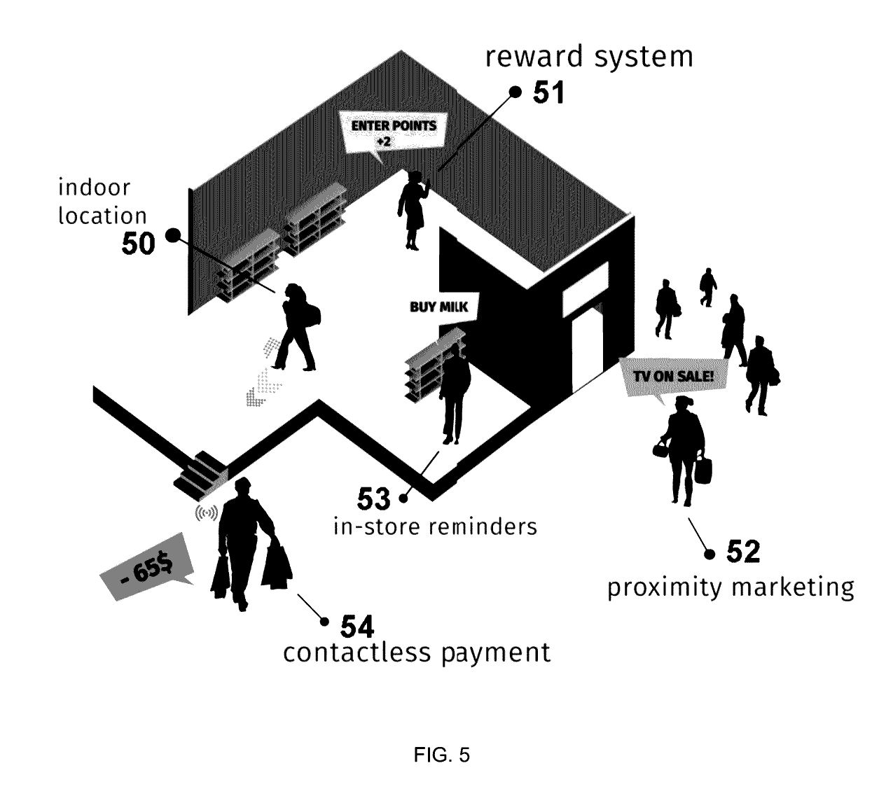

FIG. 5 depicts an example scenario to illustrate the sample shop covered by many Active-Micro-Location-based device units all over the halls, shops, elevators etc,

Shoppers not near one of the Active-Micro-Location-based device unit searching for product as “Female shoes” in the mall 52.

The Active-Micro-Location-based device units all over, guide's shopper to the right shop they selected. When one enters the shop, a reward system can be activated 51 by detection of the shopper's phone ID. The shopper been guided by the light boom to product location 50. A phone apps can detect its location in the shop and an in-store-reminder will pop up 53. After finishing the shopping, the phone apps detect the shop Id and location and Contactless Payment 54 can be carrying out.

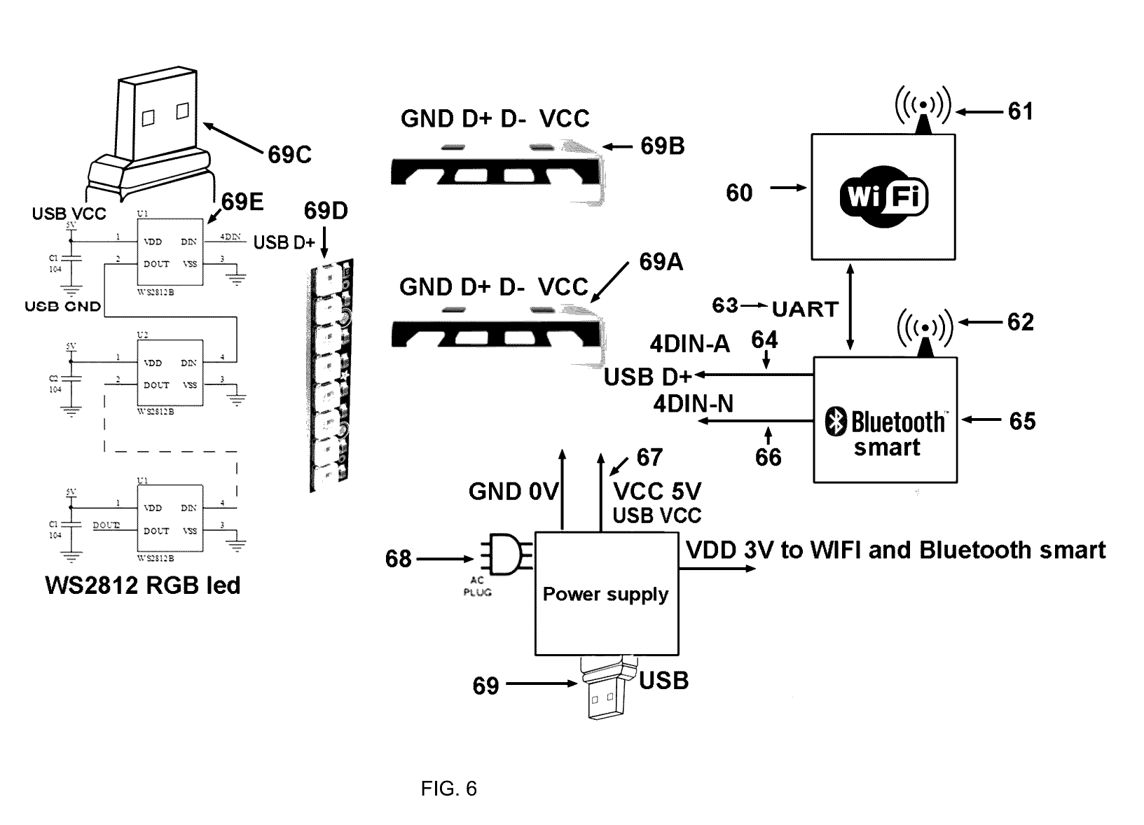

FIG. 6 depicts the electronically internal chips set of Active-Micro-Location-based device unit.

60 is the Wi-Fi chip set with all needed parts to make it works, as chips, flash, balun, crystals etc. The exact Wi-Fi chip set is not important since any Wi-Fi chip set can be used. In this example invention the chip set ESP8266EX been used and its schematics freely can be seen on the internet. The Wi-Fi has its own antenna 61 and UART 63. The UART is been used to communicate with the Bluetooth Smart 65 chip set.

65 is the Bluetooth Smart chip set with all needed parts to make it works, including PA RF amplifier that extends its range to 200 meter. The Bluetooth Smart chips have flash, crystal etc. The exact Bluetooth Smart chip set is not important since any Bluetooth Smart chip set and any RF PA can be used. In this example invention the chip set CSR1010 been use. It schematics freely can be seen on the internet. The Bluetooth Smart has its own antenna 62 and UART 63. The UART is been used to communicate with the Wi-Fi 60 chip set. UART 63 channel is important since it create a bridge between two deferant wireless Medias. If the user been detected by Bluetooth Smart 65, the phone ID is send to Wi-Fi 60 to bridge to internet data based. And if the phone ID is detected by Wi-Fi 60 chip, the UART 63 is use to update the Bluetooth Smart chip, to communicated with user smart phone.

The Bluetooth Smart 65 chip set uses its GPIO to send command to USB port 69B over line 64. The command is 1 wire protocol but other protocols can be used. The Bluetooth Smart 65 chip set used many GPIO 66 to control many USB ports 69A 69B and many others.

This 1 wire protocol is used to make the light boom 69D to be programmed and to flash the shopper animated logo.

There is also on the Active-Micro-Location-based device unit a power supply unit that supplies 67 VCC 5V or other low power to power the boom light over the USB ports. All USB ports 69B 69A get in parallel the same 5V. The power supply source is from wall plug 68 (220V/110V) or from USB male 69 plugged into phone charger or USB power bank. The power supply also 3V for the Wi-Fi and Bluetooth Smart chip set.

The light boom is a unique device that uses RGB led chip set that chain 69E output of one to the input of the other. The chip used in this invention is WS2812 led driver, but other can be used too. The light boom plugged to Active-Micro-Location-based device unit USB free ports as 69A unite its 69C USB male plug. It get over the USB plug 69C 5V, GND and 1 wire serial command to program the WS2812 RGB leds. The WS2812 RGB leds protocol can be freely seen in the internet. The boom light can be arranged in any shapes and form as seen at FIG. 4.

In other embodiments of this invention is light boom that can take a form of big light arrow or other shapes. or a full LCD/OLED/LED public screen.

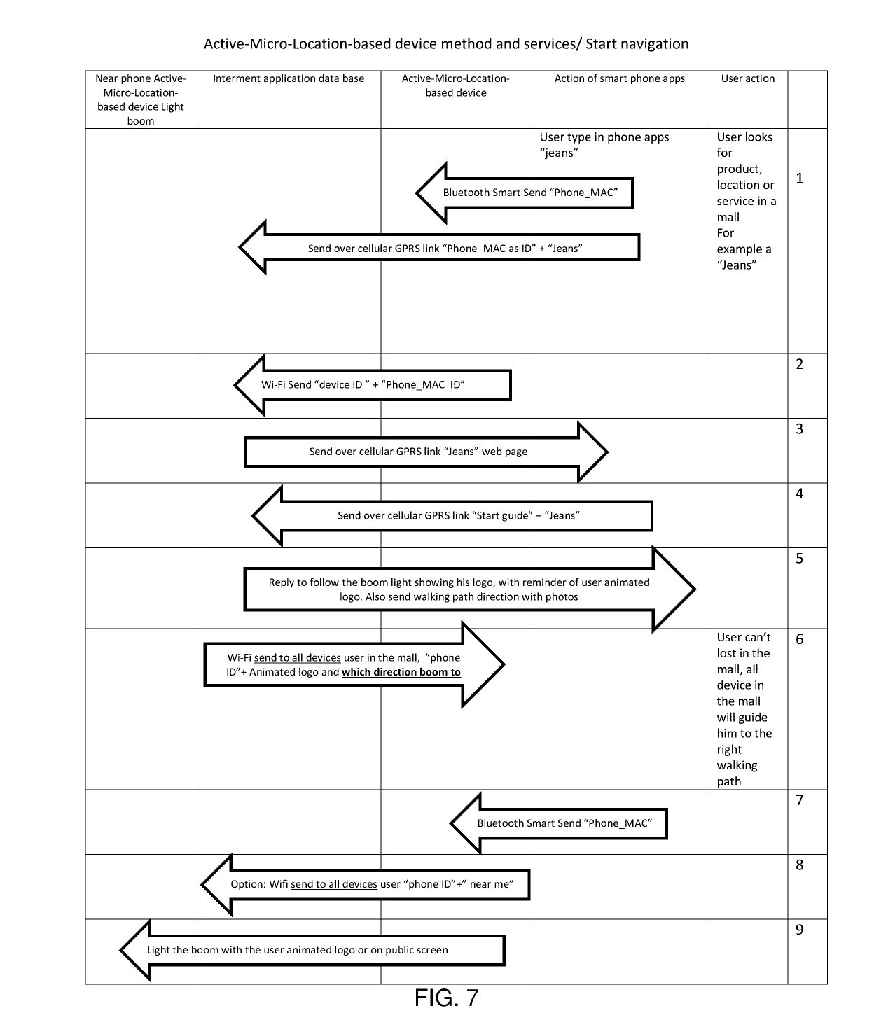

FIG. 7 is self-explained

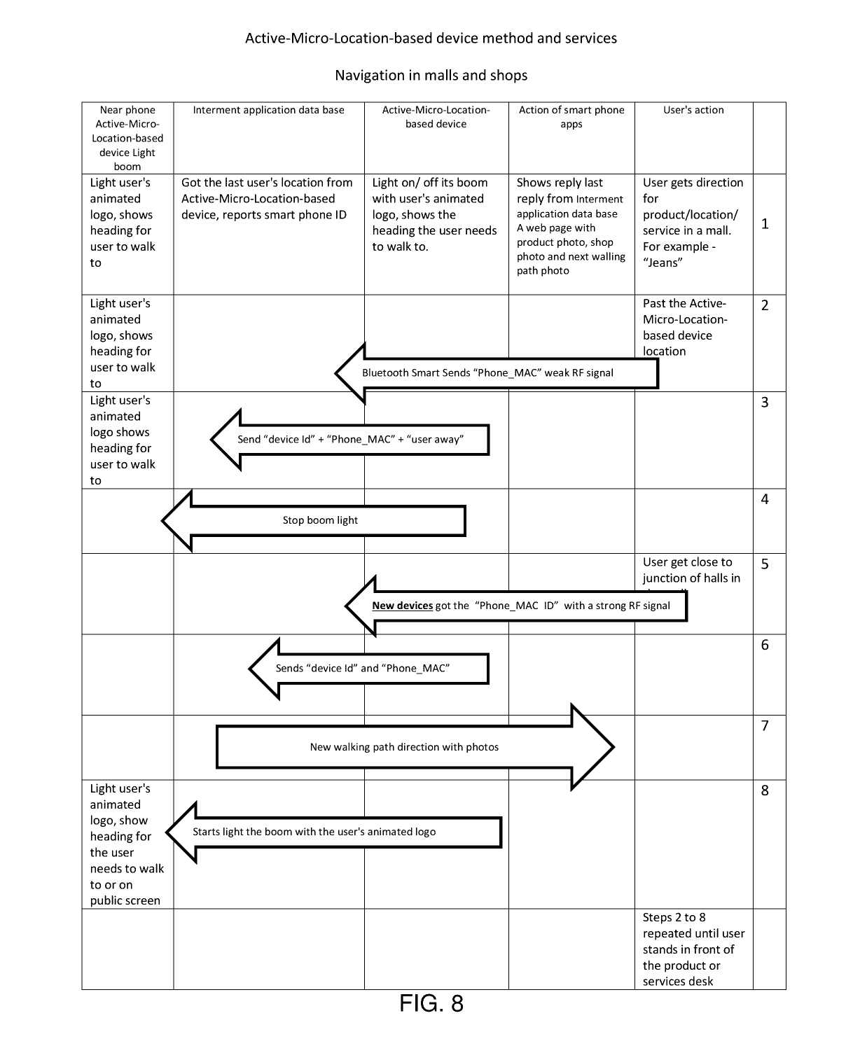

FIG. 8 is self-explained

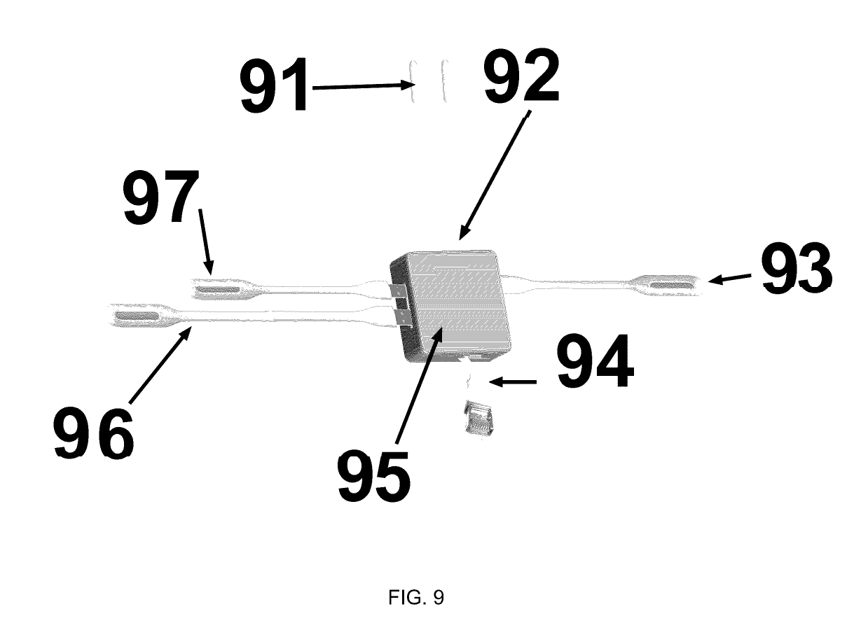

FIG. 9 depicts certain embodiments of the Active-Micro-Location-based devices
91. is a colored RGB strip light or strip of white led signal for the shopper.
92. Is second light arm locating that can flash in parallel for other shopper. Or forward a sign
93. Is light arm directed to turn right
94. Is male Ethernet connector that plugs into router RJ45 female Ethernet connector. This RJ45 male Ethernet connector RJ45 can eliminate all RF radiation out of the Active-Micro-Location-based devices. And makes it RF receiver only. All its internet data base connection is done over this wire Ethernet connector. And its Bluetooth Smart and Wi-Fi channels can be on receiving mode only. (sniffing mode). The Ethernet connector can also provide power to Active-Micro-Location-based devices.
95. The Active-Micro-Location-based device.
96. The light boom can be long or short with different shapes .it can be also full OLED public screen.
97. Sample to short arm or signal other shopper.

While the invention has been described with respect to a limited number of embodiments, it will be appreciated that many variations, modifications and other applications of the invention may be made. Therefore, the claimed invention as recited in the claims that follow is not limited to the embodiments described herein.

We claim:

1. A navigation device, comprising:
a transceiver, a controller, a visual interface and a power input;
wherein the transceiver is configured to receive, over a short range wireless information from a user's mobile phone as a mobile phone identifier and user's visual logo/text associated;
wherein the controller is configured to determine a visual direction indication to be displayed by the visual interface using information retrieved from internet data base based on user's phone ID, user searching and User location;
wherein the visual interface is configured to display to the user the visual direction indication when the mobile device of the user is within a predefined range from the navigation device;
wherein the visual direction indication comprises the mobile phone visual logo/test/video and comprises directional information for directing the user towards the destination of the user; and
Wherein the power input is configured to supply power to the transceiver, the controller and the visual interface when coupled to an external power source.

2. The navigation device according to claim 1 wherein the transceiver is configured to transmit to another navigation device, the mobile phone ID, User visual logo/text and the user destination.

3. The navigation device according to claim 2 wherein the navigation device is configured to transmit to all the other navigation device in wireless range as unlimited mesh nodes.

4. The navigation device according to claim 1 wherein the visual interface comprises different display elements that are directed to different directions; wherein the controller is configured to select a selected display element that points to a direction that once followed by the user will direct the user towards the destination of the user and to instruct the selected display element to display the User phone visual logo/text.

5. The navigation device according to claim 4 wherein the display elements are arrays of light emitting elements.

6. The navigation device according to claim 4 wherein the display elements are positioned on different pointing arms shapes of the navigation device.

7. The navigation device according to claim 1 wherein the navigation device is configured to receive the mobile phone visual logo/text and the destination of the user from internet database using over a long range wireless link as Wi-Fi or RJ45.

8. The navigation device according to claim 1 wherein the power comprises one or more a universal serial bus connectors.

9. The navigation device according to claim 1 wherein the visual interface is prevented from displaying to the user the visual direction indication when the mobile device of the user is outside the predefined range from the navigation device.

10. The navigation device according to claim 1 wherein the short range wireless link is Bluetooth Smart compliant.

11. The navigation devices according to claim 1 wherein the transceiver is configured to transmit to the mobile phone ultrasound waves or intensity changed light that convey information.

12. The user phone, according to claim 1 will display photos or video based on the user's location and proximity to the navigation device to guide his navigation.

13. The navigation device, according to claim 1, can have an Ethernet connector RJ45 to the internet server and its RF Bluetooth Smart and Wi-Fi be in Observer profile only. No RF output pollution around.

14. The navigation device, according to claim 1, can guide the user, without any application installed on the phone. Just by detection the User phone ID nearby, and the internet search data base detects the user Gmail or other user's email id account and it location near Active-Micro-Location-based device that detects its phone ID.

15. The navigation device, according to claim 1, can display to user, a targeted advertisement, based on user's location near public screen. The navigation device utilizes user's phone ID been detected nearby, User web searching products and user profile as pulled by the navigation device from the internet data base.

16. The navigation device, according to claim 1, can be used as automatic reward and payment system. Based on user's phone ID. And product profile as pulled from the store internet data base

17. The navigation device, according to claim 1, can be used as automatic in-store-reminder. Shopping list will pop up. Based on user's phone ID proximity in the store to the navigation device.

18. The navigation device according to claim 1 wherein the transceiver is configured to transmit control commands for controlling a device that differs from the mobile phone when distances between the navigation device, the device and the mobile phone do not exceeds few meters.

19. A method for providing navigation information to a user, the method comprises:
receiving, by a transceiver of a navigation device, over a short range wireless link and from a mobile phone of a user, a mobile phone identifier; receives a mobile phone visual logo/text associated with the mobile phone of the user and receive a destination from the internet data based;
determining, by a controller of the navigation device, a visual direction indication to be displayed by the visual interface;
displaying, by a visual interface of the navigation device, the visual direction indication when the mobile device of the user is within a predefined range from the navigation device;
wherein the visual direction indication comprises the mobile phone visual logo and comprises directional information for directing the user towards the destination of the user; and
supplying, by a power input of the navigation device, power to the transceiver, the controller and the visual interface, when coupled to an external power source.

20. The method according to claim 18 wherein the receiving of the mobile phone identifier is preceded by sending a request from the mobile device to a computerized system to retrieve information about a location of an article of interest; and receiving by mobile phone the destination of the user; wherein the destination of the user corresponds to the location of the article of interest.

21. The method according to claim 19 wherein the sending of the request from the mobile phone is preceded by sending, by the mobile phone and to the computerized system, a query regarding the article of interest.
